(19) United States
(12) Patent Application Publication
(10) Pub. No.: US 2018/0357605 A1
(43) Pub. Date: Dec. 13, 2018

(54) SDA Collaboration

(71) Applicant: Hexagon Technology Center GmbH, Heerbrugg (CH)

(72) Inventors: Michael D. Montgomery, Cottonwood Shores, TX (US); John Kidd, Swindon (GB); Matthew Fuller, Swindon (GB); Andrew Mitchell, Swindon (GB)

(21) Appl. No.: 16/006,014

(22) Filed: Jun. 12, 2018

Related U.S. Application Data
(60) Provisional application No. 62/518,238, filed on Jun. 12, 2017.

(51) Int. Cl. G06Q 10/10; G06F 17/50; G06Q 50/08

(52) U.S. Cl. CPC G06Q 10/101; G06F 17/5004; G06Q 10/0875; G06F 2217/06; G06F 2217/02; G06Q 50/08

(57) ABSTRACT

Systems and methods objectively manage review of design documents for engineered components to facilitate review of such documents at an appropriate level of scrutiny by assigned reviewers. Review assignment rules evaluate characteristics of the design documents to create a review assignment plan specific to each design document, facilitating application of a standard practice to the assessment such documents.

### RELATED APPLICATIONS

This patent application claims priority from provisional U.S. patent application No. 62/518,238, filed Jun. 12, 2017, entitled, “SDA Collaboration,” and naming Michael D. Montgomery; John Kidd; Matthew Fuller and Andrew Mitchell as inventors [practitioner's file 3740B/1063], the disclosure of which is incorporated herein, in its entirety, by reference.

### TECHNICAL FIELD

The present invention relates to engineering and construction projects, and more particularly to managing engineering and construction projects.

### BACKGROUND ART

Large projects consume many engineered components, and many such engineered components, and their installation, use, maintenance, etc., must meet one or more specifications or technical guidelines (such as company technical practices). Aspects of each such engineered component may be described in one or more design documents produced by an originator (e.g., the designer of the engineered component), and the content of such design documents must be reviewed against the applicable specifications or guidelines by a human reviewer. That requirement raises questions, such as which design documents need to be reviewed, and who should review them. Traditional approaches to distributing documents for review are unable to distinguish design documents that require more scrutiny from than others, and unable to specifically match design documents to reviewers. Some traditional approaches to distributing documents for review risk missing some documents that should be reviewed, and sending for review other documents that do not require review.

### SUMMARY OF EMBODIMENTS

In accordance with a first embodiments, a deterministic system for managing review of a design document for an engineered component, which engineered component is subject to a design requirement, the system includes: an EIMS module configured to store characteristics of the engineered component and design documents pertaining to the engineered component; a rules module configured to store review assignment rules, the review assignment rules including criteria by which the characteristics may be assessed; an analysis module configured to assess characteristics from the master document register against criteria from the rules module; and a plan module configured to develop a review assignment plan for the design document if the characteristics meet the criteria.

Some embodiments also include an interface module configured to receive a design document from an originator, and to transmit to the originator feedback from a team of reviewers based on review of the design document by the team of assigned reviewers.

Some embodiments also include a subscriber module configured to receive, from a subscriber, criteria defining a review assignment rule, such that the subscriber is included on the team of assigned reviewers when the characteristics meet the criteria.

In another embodiment, a non-transitory digital storage medium is encoded with instructions that, when executing on a server, establish computer processes for performing a deterministic, computer-implemented method of routing an electronic document, pertaining to compliance of a component with a component specification, wherein the computer processes include: receiving a design document corresponding to the engineered component; applying review assignment rules to the document; and creating a review assignment plan directing the design document to a team of assigned reviewers for review based on the application of the review assignment rules to the document.

In some embodiments, the computer processes further include: receiving a subscription from a subscribing reviewer, the subscription defining a review assignment rule. For example, in some embodiments, the subscription further specifies a criticality factor; and applying review assignment rules includes assessing whether the criticality factor exceeds a criticality threshold. In some embodiments, the subscription further specifies an intensity factor; and applying review assignment rules includes assessing whether the intensity factor exceeds an intensity threshold

In some embodiments, the electronic document is one of: a purchase document for the engineered component; instructions that describe handing or installation or use of the engineered component; a bill of materials for the engineered component; a maintenance manual for the engineered component; and a data sheet for the engineered component.

In some embodiments, the electronic document further includes a milestone indicator; and the review assignment plan is created in part based on the milestone indicator.

According to another embodiment, a method of managing review of a design document for an engineered component, which engineered component is subject to a design requirement, includes: receiving a design document corresponding to the engineered component; applying review assignment rules to the document; and creating a review assignment plan directing the design document to a team of assigned reviewers for review based on the application of the review assignment rules to the document.

In some embodiments, the method also includes receiving a subscription from a subscribing reviewer, the subscription defining a review assignment rule.

In some embodiments, the document is one of: a purchase document for the engineered component; instructions that describe handing or installation or use of the engineered component; a bill of materials for the engineered component; a maintenance manual for the engineered component; and a data sheet for the engineered component.

In some embodiments, the document further includes a milestone indicator; and the review assignment plan is created in part based on the milestone indicator.

In some embodiments, the subscription further specifies a criticality factor; and applying review assignment rules includes assessing whether the criticality factor exceeds a criticality threshold.

In some embodiments, the subscription further specifies an intensity factor; and applying review assignment rules includes assessing whether the intensity factor exceeds an intensity threshold.

### BRIEF DESCRIPTION OF THE DRAWINGS

The foregoing features of embodiments will be more readily understood by reference to the following detailed description, taken with reference to the accompanying drawings, in which:

FIG. 1A schematically illustrates a construction project;

FIG. 1B schematically illustrates relationships between an engineered component and design documents;

FIG. 2 schematically illustrates a document management environment;

FIG. 3 is a flowchart that illustrates an embodiment of a quality assurance review process;

FIG. 4A schematically illustrates a method of preparing an MDR;

FIG. 4B schematically illustrates a method of implementing a document review program;

FIG. 4C schematically illustrates an embodiment process of a rule flow;

FIG. 5 schematically illustrates embodiment of a system for managing review of design documents.

### DETAILED DESCRIPTION OF SPECIFIC EMBODIMENTS

Various embodiments described below objectively manage review of design documents, for engineered components, to facilitate review of such documents by assigned reviewers at an appropriate time and at an appropriate level of scrutiny, and avoid some risks inherent in subjective judgments of traditional methods. Some embodiments enable a recipient organization to define a review assignment rule(s) that deterministically assign review plans to potential reviewer(s).

Construction Project and Documentation

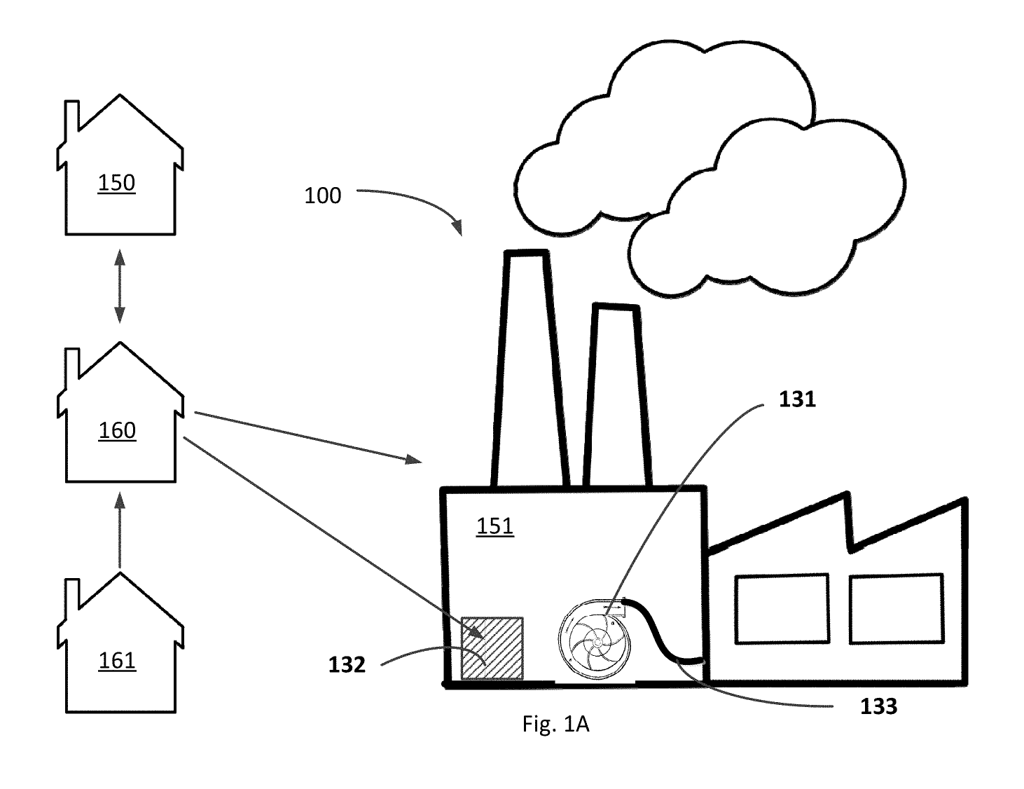

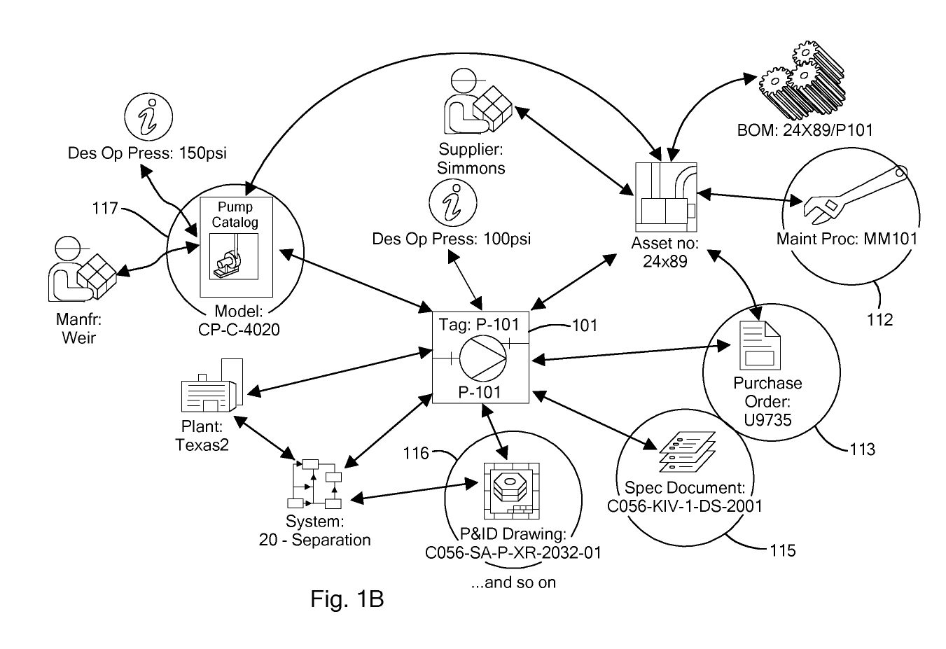

FIG. 1A schematically illustrates a construction project 100 in which a company 150 engages a contractor 160 to supply some or all parts of a physical plant 151. In this example, the project 100 involves the construction of a physical plant 151 that includes a heat exchanger 131, a large motor 132, and conduit 133, among other components. In preferred embodiments, the company 150 and contractor 160 are not affiliates (i.e., neither directly, or indirectly through one or more intermediaries, controls or is controlled by, or is under common control with, the other).

The contractor 160 may supply components 101 to the project 100, and/or may install components 101 as part of the project. The contractor 160 may produce one or more components 101 itself, or may acquire components 101 from a vendor 161.

Each component 101 has at least one corresponding design document. In keeping with the example of FIG. 1A, FIG. 1B schematically illustrates relationships between an engineered component 101 and design documents, each of which describes one or more aspects of the engineered component 101. Information in design documents may include, without limitation, part numbers (e.g., in catalog 111); installation and maintenance instructions (e.g., in manual 112); drawings (e.g., in document 116); physical details such as dimensions, weight, materials, interfaces etc. (e.g., in specification 115); and purchase and sales terms (e.g., in purchase order 113).

Document Review—Overview

In view of the size and complexity of modern construction projects, companies such a company 150 desire to review information during the design of the project and when handing over supporting information. Such a review may be referred-to as a “Quality Assurance Review” (or “QA Review”) and is a process for technical experts and specialists at the recipient company 150 to review deliverables and other documentation during the design and handover phase of a project.

In most cases these reviews are time constrained to a limited number of days in which the company 150 may identify and notify the originator (e.g., contractor 160) of any concerns regarding to the reviewed information. Consequently, one challenge is to provide the “right information to the right people at the right time” so that they can efficiently perform QA Reviews and exchange review results with the contractor 160.

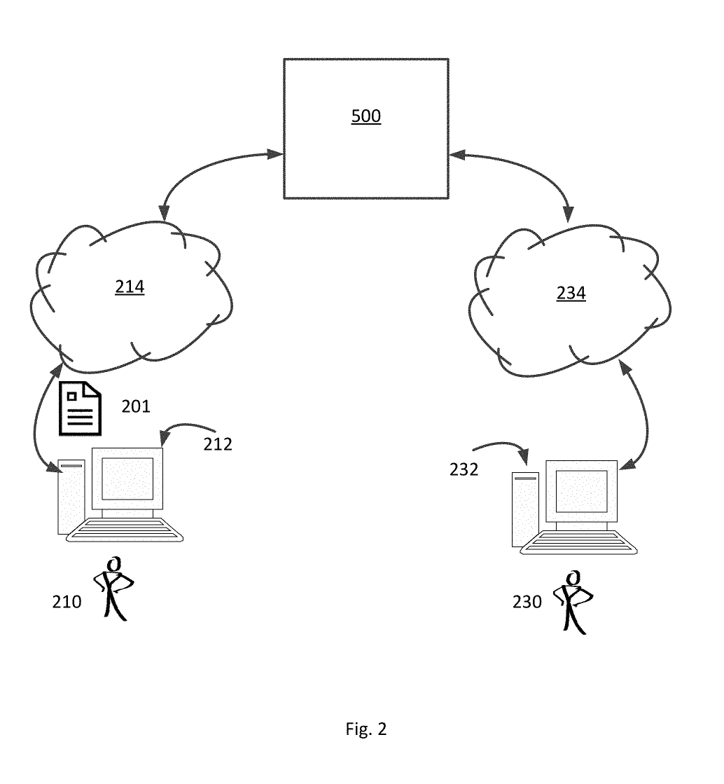

FIG. 2 schematically illustrates an application environment in which a design document 201 is originated by an originator 210 and reviewed by team of reviewers 230. For illustrative purposes, the engineered component 101 is a heat exchanger 131, and the design document 201 is a data sheet. In illustrative embodiments, the originator 210 of the design document 201 is contractor 160 hired by the company 150 to develop an engineered component 101 according to design requirement in the specification 115.

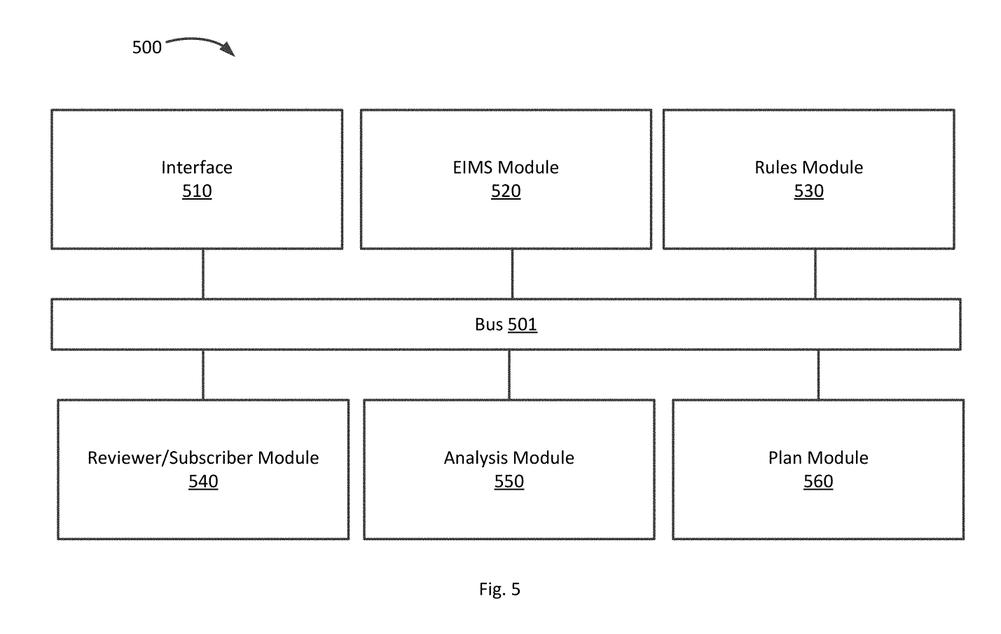

At one or more milestones in the design and development of the engineered component 101 and its design document(s) 201, the originator 210 sends the design document 201 to a reviewer 230 via a document review system 500, an illustrative embodiment of which is schematically illustrated in FIG. 5 and described below. In the embodiment of FIG. 2, the originator 210 sends the document 201 to the document review system 500 over the network 214 using the originator's computer 212. In some embodiments, the network 214 may be a dedicated network provided between the originator 210 and the system 500, such as a Local Area Network, or may be a larger network such as the Internet.

The document review system 500 evaluates the document according to review assignment rules, and creates and implements a review assignment plan for the document. Ultimately, the design document 201 is forwarded to a team of assigned reviewers 230 for review. In the embodiment of FIG. 5, the document review system 500 sends the document over the network 234 to the computer 232 for review by the team of assigned reviewers 230. It should be noted that a team of assigned reviewers 230 may include as few as a single reviewer. It should also be noted that the evaluation of the document according to review assignment rules could result in no reviewers for that document (for example, if the project is at milestone Q, and there is no rule that requires the document to be reviewed at that milestone).

The Master Document Register (“MDR”)

In preferred embodiments, prior to, or contemporaneously with the beginning of a project, or with the beginning of a phase of a project, the contractor 160 produces a Master Document Register (“MDR”). The MDR describes, at the outset, which documents the contractor 160 will produce, and for each such document, the milestone or milestones at which the contractor 160 will produce the document. Some documents may be produced only once during the project; some may be produced at each milestone of the project, and some may be produced at two or more milestones of the project.

Some documents are “issued” for a specific purpose. The purpose is often a project milestone that requires a review, such as Issue for Approval (IFA). This Issue Purpose is meta data that is provided by the contractor 160 as a field of the Master Document Register (MDR).

In keeping with the example project mentioned above, the MDR may specify that the contractor 160 will produce, at the first project milestone, for the large motor 132, a large-motor mechanical specification; a large-motor electrical schematic diagram; a large-motor power consumption chart. The MDR may also specify that the contractor 160 will produce, for the heat exchanger 131, a Heat Exchanger mechanical specification; a Heat Exchanger electrical schematic diagram; and a Heat Exchanger power consumption chart. The MDR may also specify that the contractor 160 will produce, for the conduit, an electrical specification.

At the second project milestone, the MDR may specify that the contractor 160 will produce and provide to the company 150 a revised large-motor mechanical specification and a revised large-motor power consumption chart, as well as a revised Heat Exchanger mechanical specification and a revised Heat Exchanger power consumption chart.

At the third project milestone, the MDR may specify that the contractor 160 will produce and provide to the company 150 a final large-motor schematic diagram and a final large-motor power consumption chart, as well as a final Heat Exchanger schematic diagram and a final Heat Exchanger power consumption chart; along with a final conduit specification.

In some embodiments, the contractor may not provide a given document at a given phase or milestone. Those cases are marked “N/A” in this example.

Master Doc. Reg.

| Document | Milestone 1 | Milestone 2 | Milestone 3 |
|---|---|---|---|
| Large-Motor | Yes | Yes (Revised) | N/A |
| Mechanical | | | |
| Specification - | | | |
| Large-Motor | Yes | N/A | Yes (Final) |
| Schematic | | | Issue Purpose: |
| Diagram | | | IFA |
| Large-Motor | Yes | Yes (Revised) | Yes (Final) |
| Power | | | |
| Consumption | | | |
| Chart | | | |
| Heat Exchanger | Yes | Yes (Revised) | N/A |
| Schematic | | | |
| Diagram | | | |
| Heat Exchanger | Yes | N/A | Yes (Final) |
| Schematic | | | |
| Diagram | | | |
| Heat Exchanger | Yes | Yes (Revised) | Yes (Final) |
| Power | | | Issue Purpose: |
| Consumption | | | IFA |
| Chart | | | |
| Conduit | Yes | N/A | Yes (Final) |
| Specification | | | |
| Issue Purpose | N/A | N/A | IFA |

After the contractor 160 produces the MDR, the contractor 160 provides the MDR to the company 150. The company 150 and the contractor 160 may exchange feedback and suggest changes to one another, until both parties are satisfied with the MDR.

Engineering Information Management System (“EIMS”)

The company 150 maintains an Engineering Information Management System (“EIMS”) database to store information about engineered components 101, their characteristics and design artifacts, including relationships that provide context and allow evaluation of the characteristics of related items. Such information may include, for example, name(s) of document(s) that include information about or define an engineered component, such as the design documents described above; the name of the engineered component 101; the name of the design document 201, and/or characteristics of the engineered component 101 to which the design document 201 relates. Such characteristics may include size; capacity; type of interface; constituent materials; process fluids; and/or manufacturer's model number, to name but a few illustrative examples.

Context information could include, for example, information that correlates an engineered component and its documentation (e.g., Component A is detailed in Drawing X), and information that describes how the engineered component relates to other components or systems (e.g., Component A is a constituent of System Y). Such information enables evaluations, such as: locate all documents that are related to components within System Y, which would, based on the foregoing example, identify Drawing X. Consequently, in general, the EIMS specifies a relationship between an engineered component 101 and design documents 201 related to the engineered component 101.

Content of the EIMS is preferably defined and/or specified at or near the beginning of the design and development of an engineered component 101, for example in collaboration between the company 150 (which is the customer) for the engineered component 101 (represented by a review assignment team 230) and a contractor 160 (ultimately, the originator 210 of design documents 201) responsible for the design and development.

The design document 201 submitted for review may also have information useful for and used in developing a review assignment plan. For example, some projects have document review requirements at some project milestones (e.g., “Milestone 1;” “Initial Review;” “End of Mechanical Design;” “End of Electrical Design;” “Completion of Maintenance Manual;” “Final Review”). Consequently, the design document 201 may include a milestone indicator specifying a milestone at which the document is being delivered. A review assignment plan may then be created based, in part, on the milestone indicator.

The EIMS may also include a criticality factor as a way to further characterize an engineered component 101, to provide an additional way to distinguish design documents from one another, and to create review assignment plans accordingly. For example, an engineered component 101 that takes a long time to replace if it fails, or that could be very expensive to replace, or that can cause death or injury if something goes wrong, may be given a higher criticality factor than an engineered component 101 that does not have those characteristics. A designer may establish a criticality factor based on her understanding of the engineered component and its intended application and operating environment. In illustrative embodiments, the criticality factor ranges from 1 to 5, with 1 being low criticality, 2 being moderately-low criticality; 3 being moderate criticality; 4 being moderately-high criticality; and 5 being high criticality.

The EIMS may also include an intensity factor as a way to further characterize an engineered component 101, to provide an additional way to distinguish design documents from one another, and to create review assignment plans accordingly. For example, a design document coming from a well-established contractor (e.g., supplier 161) may be more trusted, and therefore may be have a lower intensity factor, than a design document from a newer contractor 160. A higher intensity factor may mean that the design document requires more reviews by more reviewers, and/or more experienced reviewers, and/or at more milestones, than required for a design document with a lower intensity factor. A designer may establish an intensity factor based on her understanding of the originator's ability to provide dependable design and/or based on qualifications a team of assigned reviewers 230. In illustrative embodiments, the intensity factor ranges from 1-4, with 1 being low intensity, 2 being moderately-low intensity; 3 being moderate intensity; and 4 being high intensity.

The EIMS may also include information about potential reviewers. For example, the EIMS may specify that Engineer M is to be included on a team of assigned reviewers 230 to review diagrams of all engineered components destined for the cooling tower, and that Engineer E is to be included on a team of assigned reviewers 230 to review specifications for all engineered components that draw more than 1.2 kW of power.

In keeping with the example above, an EIMS database may include, for example, the information in the table below.

Project Name: Project Z

| Eng. Information | Heat Exchanger | | Large Motor | | Conduit | |
|---|---|---|---|---|---|---|
| Document Name | Data sheet for | | Schematic | | Conduit | |
| | Heat Exchanger; | | diagram | | specification | |
| Installation Loc. | Cooling tower | | Pump house | | Throughout plant | |
| Material | Stainless steel | | Steel | | Plastic | |
| Power Draw | 1.5 | kW | 3 | kW | Zero | |
| Inlet Pressure | 241 | kPa | N/A | | 500 | kPa |
| Capacity | 300 | liter/min | N/A | | 500 | liter/min |
| Outside Diameter | 50 | cm | 100 | cm | 50 | cm |

| | | | |
|---|---|---|---|
| Criticality | 3 | 1 | 1 |
| Intensity | 2 | 3 | 1 |
| Milestone Review | Initial review | | |
| Required reviewer | Engineer E | Engineer E | |

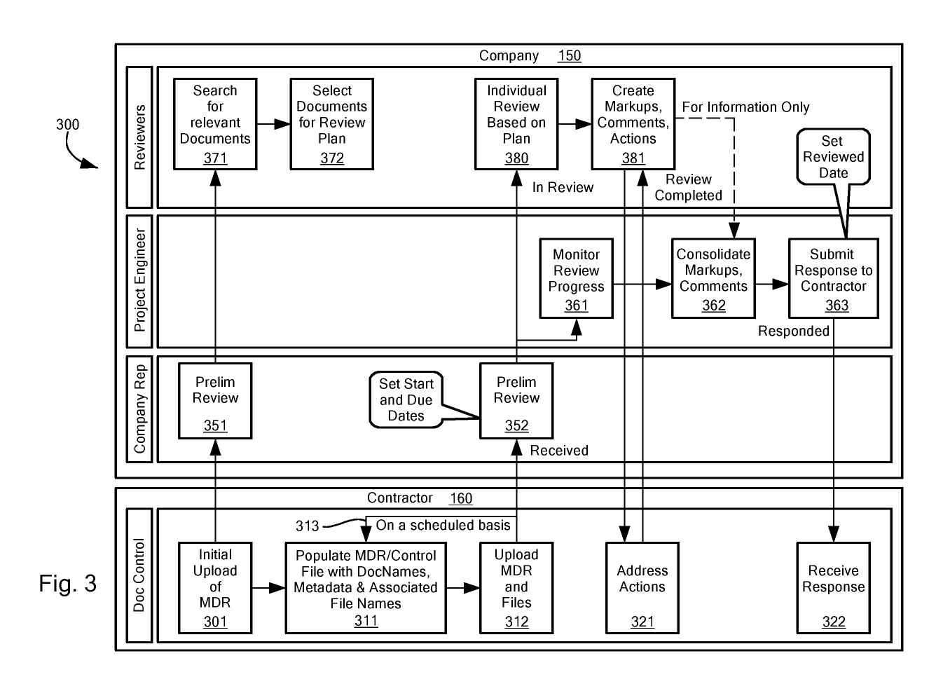

Quality Assurance Review Process—FIG. 3

FIG. 3 schematically illustrates an embodiment 300 of distributing project documents from a contractor 160 to a company 150 for review.

Steps 301, 351, 371 and 372 represent the creation of the MDR and rules as described below. Step 301 sends a draft of the MDR to an optional preliminary reviewer for review at step 351. For example, the preliminary reviewer may be the project manager of the project (e.g., Project Z). The preliminary reviewer may suggest changes, such as changes to document names and additional data to be added to the MDR.

At step 371, the draft MDR is provided to potential reviewers.

At step 372 static rules may be applied, and potential reviewers may subscribe (i.e., volunteer) to review selected documents at selected stages, as described below.

At step 311, the MDR is optionally updated with additional information, such as final document names, metadata, and associated document names. Metadata for a document may include, for example, a document number, document author, keywords included in the document, and/or which are search terms by which the document may be identified in a computer search. Upon delivery of the MDR to the customer 150, the customer creates an Initial Review Plan, which specifies, for each document 201, who at the customer 150 is assigned to review the document 201.

At step 312, the MDR and, at each milestone, documents for review are delivered by the contractor 160 to the customer 150. The handover of information is initiated by uploading documents and supporting information. Upon uploading of the documents a preliminary check is made to ensure that the uploaded documents are conformant with project requirements prior to initiating the review of the content of the documents.

The MDR and/or the documents may optionally be delivered to the preliminary reviewer (or project engineer) 352 at step 351, and optionally to a document review manager at step 361. Among other things, a project engineer may: list all of the reviews that are planned on the project; list all of the reviews that are active on the project; see the status of all reviews on the project; list all of the documents that are under review; complete QA Review and respond to the contractor 160), and act as a consolidator (described further below).

It should be noted that the Initial Review Plan may be modified between project milestones, or at any other time, at step 313, to produce a Revised Review Plan, and the Revised Review Plan is used in place of the Initial Review Plan from that point forward. A Revised Review Plan may be modified in the same way.

The documents are also delivered to the reviewers, according to the Initial Review Plan (or a Revised Review Plan) at step 380.

The period for review is contractually limited to a number of days. The start date and due date of the review are automatically set when the new revision of the document is added.

Each document may be reviewed by multiple reviewers simultaneously. These reviews function independently, however each reviewer 230 may see the comments and markups of all other reviewers 230. As the reviewers add comments, actions or markups to the document they are visible to the other reviewers. The reviewer may see this information across all projects/plants that they have access to. Upon completion of all of the reviews a final consolidation will be performed to ensure that the comments and markups don't contain duplicates and they are ready for return to the originating contractor 160. Actions that are generated as a result of the review follow a distinct work process to ensure that they are shepherded to completion. Actions may be initiated during any stage of a review. A more detailed description of Actions and Issues may be found in the Actions and Issues approach document.

Upon reviewing a document, at step 381 each reviewer produces a marked-up copy of the document (a “markup”), and/or comments on the document, and/or a list of one or more actions to be take on, or in response to, the document. A reviewer may also request and review a list all of his or her reviews that are currently active and their state; create Markups and Comments; view Markups and Comments created by others; create Actions and direct them to the contractor 160; view all Actions; view only his or her Actions; modify fields on an Action that are not fields owned by the contractor; generate PDF renditions and attach them to the Action; attach other reference files to the Action; and/or act as a consolidator (described below).

Issues and Actions

Any type of review may trigger an Action or an Issue.

Action items are observations made during the reviews that require additional follow up. Each action item is put into a workflow and managed separately. An Action is a topic that is assigned to an individual to steward until completion. Completion may be an “acceptable mitigation plan”

An Issue is a topic with a lower priority than an Action. An issue is also assigned to an individual for governance. It is recorded and tracked. An Issue may escalate into one or more Actions. If an issue is not escalated it does not require closure.

Review Status

Some embodiments track the status of the work of various reviews and reviewers at step 381. For example, a document review status may be set to any of the following:

a. Not Started | Initial default state

b. Waived | No review required at this time

c. Reviewed | Reviewed without comment.

d. Reviewed with Actions | Mitigation and follow-up review required

e. Reviewed with Issues | May require additional follow up

Consolidation

At step 362, the document review manager (or consolidator) aggregates (or consolidates) the output from the reviewers (e.g., the markups, comments and actions produced by the reviewers). In general, the document review manager may list all of the reviews that are planned on my project, and view all of the markups, comments and actions related to a document. The document review manager may edit one or more items of the reviewers' output. For example, the document review manager may delete duplicate comments and actions, or may combine similar comments and actions. The document review manager may also add his or her own markups, comments and suggestions. In addition, document review manager may also

The product of the document review manager's work forms a Feedback Report from the company 150 to the contractor 160.

Then, at step 363, the document review manager transmits the Feedback Report from the company 150 to the contractor 160.

At step 322, the Contactor receives the Feedback Report, and acts accordingly to revise the documents or take other action in response to the Feedback Report. For example, in addition to revising the documents, action may include changing or re-engineering components and materials to be used by the contractor 160, or methods to be used by the contractor 160, in executing the project. Other actions may include even revising the MDR, and/or changing rules regarding document review. Such revisions or other actions are preferably completed prior to the next phase, if any, or prior to completion of the project.

Eventually, the project is completed and the foregoing processes end.

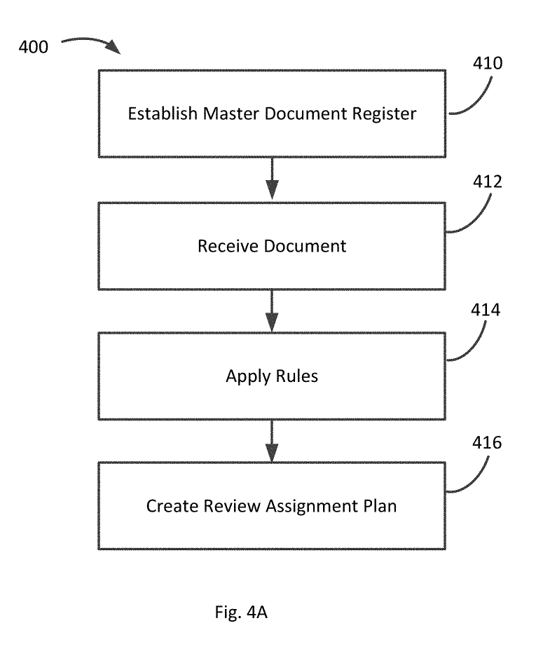

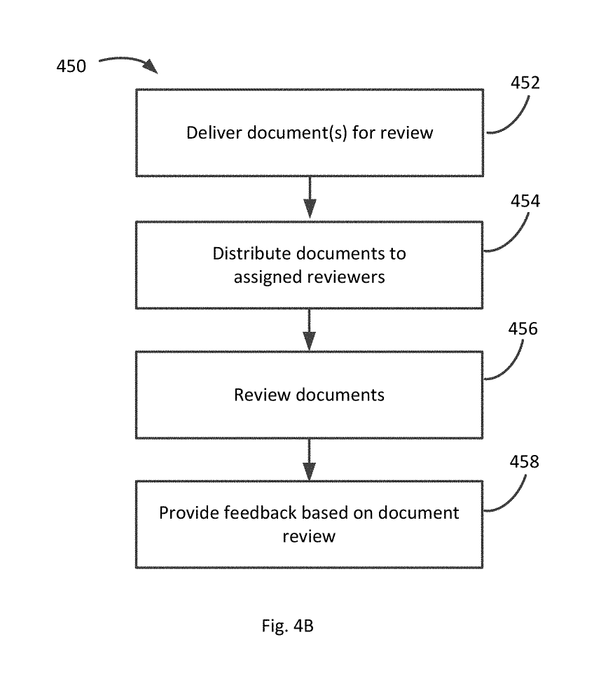

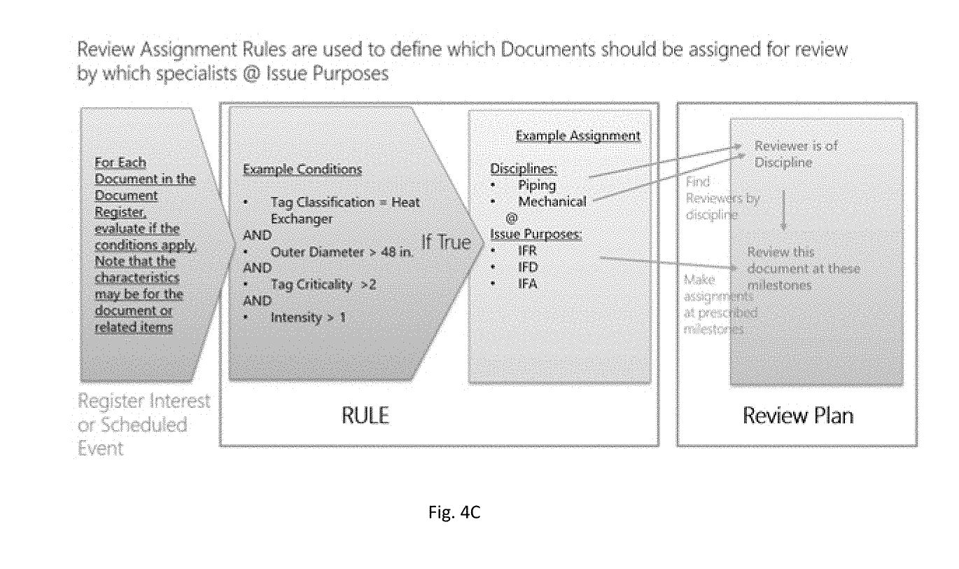

An alternate embodiment of a method 400 of creating an initial review plan is schematically illustrated by the flow chart of FIG. 4A.

At step 410, the contractor 160 establishes the MDR as described above, and provides the MDR to the company 150.

At step 412, the company 150 receives the MDR from the contractor 160.

Step 414 applies rules to the MDR.

Step 416 creates an initial review plan, based on the application of the rules to the MDR.

An alternate embodiment of a method 450 of performing a quality assurance document review process is schematically illustrated by the flow chart of FIG. 4B.

At step 452, the contractor 160 sends, and the customer 150 receives, one or more documents listed in the MDR.

At step 454, the customer 160 distributes the documents to the assigned reviewers according to the initial (or a revised) review plan.

At step 456, the assigned reviewers review the documents and at step 458 provide feedback as described above.

FIG. 4C schematically illustrates an embodiment process of a rule flow that creates a review plan.

Subscribers

Preferred embodiments allow a potential reviewer to specify characteristics of the design documents 201 he or she wishes to review. Such a potential reviewer may be referred to as a “subscriber,” and the subscriber's specified characteristics may be referred to as a “subscription.”

Often the selection by a subscriber of documents for review is based on related information, such as the equipment the document is related to and the criticality rating of that equipment. In preferred embodiments, while selecting documents, the potential reviewer should see the name, description and classification and have the ability to view the document prior to selection. Moreover, the potential reviewers may select for review “All revisions” for review, or may select a document based on its specific “Issue Purpose.”

In contrast to prior art methods, which indiscriminately “pushed” documents to reviewers (e.g., by brute force), the present subscription model enables the subscriber to “pull” the documents he wants to review.

As an example, a Supervisor may subscribe to review each design document 201 for each engineered component 101 destined for installation in a cooling tower, and that has a criticality factor greater than 2.5. Such a criticality factor may be included in the EIMS, and/or in the design document 201 itself, for example by prior agreement between the originator 210 and the team of assigned reviewers 230.

As another example, a subscriber may, among other things, select document revisions based on the document's Issue Purpose; select to review all revisions of the document; select multiple documents for review; list all of the reviews that such reviewer planned and see which criteria are selected; modify his or her selection of documents & revisions for review; and/or decide to waive or reject a review (when this happens the status of such review is set to “Waived”).

The subscription defines a review assignment rule that assesses those characteristics, and causes the Plan Module 560 (discussed below) to create a review assignment plan for the design document that includes at least the subscriber. In the context of the illustrative example, since the criticality factor is greater than 2.5, the rule specifies that the review assignment plan for that design document 201 includes the Supervisor. Similarly, when a document is uploaded and the Issue Purpose of the new revision matches the selection made by a subscribing reviewer, a review is triggered and the reviewer is notified.

Subscriber Chart

| Document | Milestone 1 | Milestone 2 | Milestone 3 |
|---|---|---|---|
| Large-Motor | | | |
| Mechanical | | | |
| Specification | | | |
| Large-Motor | Engineer E | N/A | Engineer E |
| Schematic | | | |
| Diagram | | | |
| Large-Motor | Engineer M | | |
| Power | | | |
| Consumption | | | |
| Chart | | | |
| Heat Exchanger | Engineer N | | Engineer N and |
| Data Sheet | | | Engineer M |
| Heat Exchanger | Engineer E | N/A | Engineer E |
| Schematic | | | |
| Diagram | | | |
| Heat Exchanger | | | |
| Power | | | |
| Consumption | | | |
| Chart | | | |
| Conduit | Engineer C | N/A | Engineer C |
| Specification | | | |

Review Assignment Rules

Preferred embodiments develop and apply rules used to produce a review plan that specifies how (e.g., which reviewers and at what milestones) the documents are to be distributed, at each milestone, each to one or more appropriate reviewers. In general, for each document listed in the MDR, the rules determine for each milestone of the project which (if any) reviewers are to review the given document at that phase, and assign that reviewer to that document for that phase.

Generally, review assignment rules operate, in part, on associations between engineered components 101 and design documents 201 based on characteristics of the engineered components 101 as recorded in the EIMS. More specifically, review assignment rules evaluate the design characteristics of the engineered component 101 related to a design document 201 for creating review assignments. For example, a review assignment rule includes a set of criteria that are compared against the characteristics of the records in the EIMS (and, in cases in which the design document 201 includes additional characteristics, against those additional characteristics as well), and if the characteristics match the criteria, a Plan Module 560 creates a review assignment plan for the design document.

Review assignment rules may fall into one or more category of types. A static rule specifies that a given document at a given phase is to be reviewed by a specified reviewer. For example, a static rule may specify that the large-motor mechanical specification must be reviewed by Engineer M at Milestone 1, and by both Engineer M and Engineer N at Milestone 3. Another static rule may specify that the large-motor power consumption chart and the heat exchanger power consumption chart must be reviewed by Engineer H at all three phases.

Review Chart based on static rules

| Document | Milestone 1 | Milestone 2 | Milestone 3 |
|---|---|---|---|
| Large-Motor | Engineer M | | Engineer M and |
| Mechanical | | | Engineer N |
| Specification | | | |
| Large-Motor | | N/A | |
| Schematic | | | |
| Diagram | | | |
| Large-Motor | Engineer H | Engineer H | Engineer H |
| Power | | | |
| Consumption | | | |
| Chart | | | |
| Heat Exchanger | | | |
| Data Sheet | | | |
| Heat Exchanger | | N/A | |
| Schematic | | | |
| Diagram | | | |
| Heat Exchanger | Engineer H | Engineer H | Engineer H |
| Power | | | |
| Consumption | | | |
| Chart | | | |
| Conduit | | N/A | |
| Specification | | | |

A subscription rule specifies that a given document at a given milestone is to be reviewed by a reviewer who has subscribed (i.e., self-selected or volunteered) to review that document. For example, the company's engineering community may be presented with the MDR, and each member of the engineering community may be given the opportunity to select documents that he or she wants to review. In keeping with the foregoing example, Engineer M may subscribe to review the large-motor power consumption chart at Milestone 1, even though the static rules described above do not assign that review to Engineer M. In this way, a chart correlating documents, project phase and reviewers can be compiled.

It should be noted that some documents at some milestones may not have a reviewer, either by a static rule or by subscribers.

When there are documents for which no reviewer has been assigned (e.g., at Milestone 2 in the foregoing example, the Large-Motor Mechanical Specification and the Heat Exchanger Mechanical Specification), the system may automatically assign a reviewer (e.g., from among the other reviewers already assigned to those documents: Engineer M and Engineer N, respectively), or a user or supervisor may assign a reviewer.

Example Rules

As a simple example, one rule may assess the name of the design document 201, and subsequently access the record for that design document 201 in the EIMS. In the context of the description above, if the design document 201 is a data sheet for a heat exchanger, the rule specifies that a review assignment plan for that design document should include Engineer M:

If: “Engineered Component”=“Heat Exchanger”

Then: add Engineer M to review assignment team.

As another example:

If: “Installation Location”=“Cooling Tower”;

Then: add Engineer M and Engineer E to review assignment team.

As another example:

If: Milestone=“Initial Review”

Then: add Supervisor to review assignment team;

Else: add Engineer M and Engineer E to review assignment team.

As another example:

If: Milestone=“Completion of Maintenance Manual,”

Then: add Ernie Editor to review assignment team.

Some embodiments of rules operate on criticality factor or intensity factor. For example, with regard to a given document, a rule may access an EIMS database record for that document to obtain the document's criticality factor and/or intensity factor.

If Criticality Factor is greater than or equal to 3, then assign a reviewer.

If Intensity Factor is greater than or equal to 4, then assign a reviewer.

If the sum of the Criticality Factor and the Intensity Factor is greater than or equal to 5, then assign a reviewer.

Additional illustrative embodiments of rules are disclosed below.

Assign Engineer M to review the Large-Motor Mechanical Specification at Milestone 1 of Project Z.

Assign John Doe (i.e., Assigned Reviewer LMMS1) to review the Large-Motor Mechanical Specification at Milestone 2 of Project Z.

Assign Engineer H to review the Heat Exchanger Power Consumption Chart at Milestone 2 of Project Z.

Assign Engineer C to review the Conduit Specification at Milestone 3 of Project Z.

In some embodiments, a rule may also specify text to be sent to the specified reviewer. For example, for a document at Phase N of a Project Z, an example text could be: “You are the assigned reviewer for the attached document at Phase N of Project Z. Please review the document and send questions and feedback to the Document Review Manager, Mr. D.”

Applying the Rules

Once the rules are established, they are applied to the documents of the MDR to produce an initial review plan.

Initial Review Plan

The Initial Review Plan results from the application of the rules to the MDR. In keeping with the foregoing examples, the Initial Review Plan for Project Z includes at least the following elements:

Project Name: Project Z
Doc. Review Mgr.: Mr. D

| Document | Milestone 1 | Milestone 2 | Milestone 3 |
|---|---|---|---|
| Large-motor | Engineer M | Assigned | Engineer M and |
| mechanical | | Reviewer | Engineer N |
| specification | | LMMS1 | |
| Large-motor | Engineer E | N/A | Engineer E |
| schematic | | | |
| diagram | | | |
| Large-motor | Engineer H and | Engineer H | Engineer H |
| power | Engineer M | | |
| consumption chart | | | |
| Heat Exchanger | Engineer N | Assigned | Engineer N and |
| Data Sheet | | Reviewer | Engineer M |
| | | SMMS1 | |
| Heat Exchanger | Engineer E | N/A | Engineer E |
| schematic | | | |
| diagram | | | |
| Heat Exchanger | Engineer H | Engineer H | Engineer H |
| power | | | |
| consumption chart | | | |
| Conduit | Engineer C | N/A | Engineer C |
| Specification | | | |

It should be noted that that, in the foregoing charts, Engineer C, Engineer E, Engineer M, Engineer N and Engineer H are specific, identifiable individuals.

It should also be noted that the identity of “Assigned Reviewer LMMS1” is correlated a specific identifiable individual (e.g., John Doe), or an individual identifiable based on information in the chart and some additional information. For example, the chart may specify that “Assigned Reviewer LMMS1” is whoever is the “Current large motor engineer for Project Z,” and the additional information would correlate a specific individual to that position (e.g., the current large motor engineer for Project Z is John Doe, jdoe@projectZ.company.com).

As will be understood from the foregoing examples, at Milestone 1 of Project Z, Engineer M will review the Large-Motor Mechanical Specification. Upon receipt of the Large-Motor Mechanical Specification at Milestone 1 of Project Z, send the Large-Motor Mechanical Specification to Engineer M for review.

At Milestone 2 of Project Z, John Doe will review the Large-Motor Mechanical Specification. Upon receipt of the Large-Motor Mechanical Specification at Milestone 2 of Project Z, send the Large-Motor Mechanical Specification to John Doe for review.

At Milestone 2 of Project Z, Engineer H will review the Heat Exchanger Power Consumption Chart. Upon receipt of the Heat Exchanger Power Consumption Chart at Milestone 2 of Project Z, send the Heat Exchanger Power Consumption Chart to Engineer H for review.

At Milestone 3 of Project Z, Engineer C will review the Conduit Specification. Upon receipt of the Conduit Specification at Milestone 3 of Project Z, send the Conduit Specification to Engineer C for review.

System

FIG. 5 schematically illustrates an embodiment of the document review system 500, and includes several modules, described below, in communication over a bus 301. Some or all portions of the review system 500 may be implemented on a digital computer, and in some embodiments may be implemented on the computer 232 of the team of assigned reviewers 230. Generally, the system 500 performs portions of the processes of FIG. 3, FIG. 4A and FIG. 4B described above.

The review system 500 has a communications Interface Module 310 configured to electronically interface to the network 214, as well as to the network 234 if the system 500 is not resident on computer 234. As described above, the originator 210 communicates with the system 500 through network 214. Similarly, the system 500 communicates with the team of assigned reviewers 230 via network 234. Although network 214 and network 234 are schematically illustrated as distinct networks in FIG. 2, they could be a single network.

The review system 500 also includes an Engineering Information Management System Module 520 (EIMS) configured to store the Engineering Information Management System described above. In some embodiments, the EIMS module 520 may store and maintain one or more document registers (“DR”), each of which stores the names of some or all documents that describe a given engineered component. As an example, a DR may include a reference list of design documents and meta-data about those documents.

The review system 500 also includes Rules Module 530 configured to store and/or apply review assignment rules to the design document 201.

The system 500 further includes a Reviewer/Subscriber Module 540 configured to receive, store, and provide to other modules information relating to reviewers, including subscribers.

Finally, the system 500 includes a Plan Module 560 configured to create a review assignment plan for the design document 201. The review assignment plan at least identifies a team of assigned reviewers 230.

The review assignment plan may specify other review criteria, such as the order in which members of the team of assigned reviewers 230 review the design document 201, deadlines for completing their review(s), etc. In some embodiments, the review assignment plan may also include instructions to the team of assigned reviewers. For example, the review assignment plan may include a checklist, such as: (i) check the heat exchanger's footings and (ii) confirm that the noise output of the heat exchanger's motor does not exceed its specification.

Once the review assignment plan is created, the Interface Module 510 sends the design document to the team of assigned reviewers 230.

Embodiments summarized above and described in further detail below have the effect of transforming the nature of interaction between the customer 150 and contractor 160 from one that was controlled by subjective judgments from several people to one that is objectively controlled by rules. Moreover, some embodiments provide flexibility in creating the rules, such as allowing a person to subscribe to a review of a given document (or volunteer to be a reviewer) at one or more given milestone of a project. The activities defined by the claims below are not well-understood, routine, or conventional to a skilled artisan in the field of the present invention.

As used herein, a “computer process” is the performance of a described function in a computer using computer hardware (such as a processor, field-programmable gate array or other electronic combinatorial logic, or similar device), which may be operating under control of software or firmware or a combination of any of these or operating outside control of any of the foregoing. All or part of the described function may be performed by active or passive electronic components, such as transistors or resistors. In using the term “computer process” we do not necessarily require a schedulable entity, or operation of a computer program or a part thereof, although, in some embodiments, a computer process may be implemented by such a schedulable entity, or operation of a computer program or a part thereof. Furthermore, unless the context otherwise requires, a “process” may be implemented using more than one processor or more than one (single- or multi-processor) computer.

Various embodiments of the invention may be implemented at least in part in any conventional computer programming language. For example, some embodiments may be implemented in a procedural programming language (e.g., “C”), as a visual programming process, or in an object-oriented programming language (e.g., “C++”). Other embodiments of the invention may be implemented as a pre-configured, stand-along hardware element and/or as preprogrammed hardware elements (e.g., application specific integrated circuits, FPGAs, and digital signal processors), or other related components.

In an alternative embodiment, the disclosed apparatus and methods (e.g., see the methods described above) may be implemented as a computer program product for use with a computer system. Such implementation may include a series of computer instructions fixed either on a tangible, non-transitory medium, such as a computer readable medium (e.g., a diskette, CD-ROM, ROM, or fixed disk). The series of computer instructions can embody all or part of the functionality previously described herein with respect to the system.

Those skilled in the art should appreciate that such computer instructions can be written in a number of programming languages for use with many computer architectures or operating systems. Furthermore, such instructions may be stored in any memory device, such as semiconductor, magnetic, optical or other memory devices, and may be transmitted using any communications technology, such as optical, infrared, microwave, or other transmission technologies.

Among other ways, such a computer program product may be distributed as a removable medium with accompanying printed or electronic documentation (e.g., shrink wrapped software), preloaded with a computer system (e.g., on system ROM or fixed disk), or distributed from a server or electronic bulletin board over the network (e.g., the Internet or World Wide Web). In fact, some embodiments may be implemented in a software-as-a-service model (“SAAS”) or cloud computing model. Of course, some embodiments of the invention may be implemented as a combination of both software (e.g., a computer program product) and hardware. Still other embodiments of the invention are implemented as entirely hardware, or entirely software.

The embodiments of the invention described above are intended to be merely exemplary; numerous variations and modifications will be apparent to those skilled in the art. All such variations and modifications are intended to be within the scope of the present invention as defined in any appended claims.

What is claimed is:

1. A deterministic system for managing review of a design document for an engineered component, which engineered component is subject to a design requirement, the system comprising:
an EIMS module configured to store a characteristics of the engineered component and of design documents pertaining to the engineered component;
a memory to store a master document register describing the design document;
a rules module configured to store review assignment rules, the review assignment rules including criteria by which the characteristics may be assessed;
an analysis module configured to assess the characteristics against criteria by applying a rule from the rules module; and
a plan module configured to develop a review assignment plan for the design document if the characteristics meet the criteria.

2. The system of claim 1, further comprising an interface module configured to receive a design document from an originator, and to transmit to the originator feedback from a team of assigned reviewers based on review of the design document by the team of assigned reviewers.

3. The system of claim 1, further comprising a subscriber module configured to receive, from a subscriber, criteria defining a review assignment rule, such that the subscriber is included on the team of assigned reviewers when the characteristics meet the criteria.

4. A nontransitory digital storage medium encoded with instructions that, when executing on a server, establish computer processes for performing a deterministic, computer-implemented method of routing an electronic document, pertaining to compliance of a component with a component specification, wherein the computer processes comprise:
receiving a design document corresponding to the engineered component;
applying review assignment rules to the document; and
creating a review assignment plan directing the design document to a team of assigned reviewers for review based on the application of the review assignment rules to the document.

5. The nontransitory digital storage medium of claim 4 wherein the computer processes further comprise:
receiving a subscription from a subscribing reviewer, the subscription defining a review assignment rule.

6. The nontransitory digital storage medium of claim 5 wherein:
the subscription further specifies a criticality factor; and
applying review assignment rules includes assessing whether the criticality factor exceeds a criticality threshold.

7. The nontransitory digital storage medium of claim 5 wherein:
the subscription further specifies an intensity factor; and
applying review assignment rules includes assessing whether the intensity factor exceeds an intensity threshold

8. The nontransitory digital storage medium of claim 4, wherein the electronic document is one of:
a purchase document for the engineered component;
instructions that describe handing or installation or use of the engineered component;
a bill of materials for the engineered component;
a maintenance manual for the engineered component; and
a data sheet for the engineered component.

9. The nontransitory digital storage medium of claim 4 wherein:
the electronic document further includes a milestone indicator; and
the review assignment plan is created in part based on the milestone indicator.

10. A method of managing review of a design document for an engineered component, which engineered component is subject to a design requirement, the method comprising:
receiving a design document corresponding to the engineered component;
applying review assignment rules to the document; and
creating a review assignment plan directing the design document to a team of assigned reviewers for review based on the application of the review assignment rules to the document.

11. A method of claim 10 further comprising:
receiving a subscription from a subscribing reviewer, the subscription defining a review assignment rule.

12. A method of claim 10 wherein the document is one of:
a purchase document for the engineered component;
instructions that describe handing or installation or use of the engineered component;
a bill of materials for the engineered component;
a maintenance manual for the engineered component; and
a data sheet for the engineered component.

13. A method of claim 10 wherein:
the document further includes a milestone indicator; and
the review assignment plan is created in part based on the milestone indicator.

14. A method of claim 11 wherein:
the subscription further specifies a criticality factor; and
applying review assignment rules includes assessing whether the criticality factor exceeds a criticality threshold.

15. A method of claim 11 wherein:
the subscription further specifies an intensity factor; and
applying review assignment rules includes assessing whether the intensity factor exceeds an intensity threshold.
